(19) United States
(12) Patent Application Publication
(10) Pub. No.: US 2024/0181669 A1
(43) Pub. Date: Jun. 6, 2024

(54) ENERGY EFFICIENT PUMP AND RELATED SYSTEMS AND METHODS

(71) Applicant: Shape Technologies Group, Inc., Kent, WA (US)

(72) Inventor: Per Edarp, Fridlevstad (SE)

(21) Appl. No.: 18/523,439

(22) Filed: Nov. 29, 2023

Related U.S. Application Data
(60) Provisional application No. 63/429,475, filed on Dec. 1, 2022.

(51) Int. Cl. B26F 3/00; F15B 3/00

(52) U.S. Cl. CPC B26F 3/004; F15B 3/00

(57) ABSTRACT

An energy efficient fluid pressurization system includes a hydraulic pressure chamber, a piston positioned within an interior cavity of the hydraulic pressure chamber, and a pump that conveys a hydraulic fluid into a portion of the interior cavity of the pressure chamber thereby moving the piston within the interior cavity. Movement of the piston results in compression of a working fluid within a pressure vessel. A motor coupled to the pump drives the pump resulting in conveyance of the hydraulic fluid. The system may detect a change in one or more parameters, caused by a fluctuation in demand for the pressurized working fluid, and vary a speed of the pump in response to the detected change. The one or more parameters include: flow rate of the hydraulic fluid; flow rate of the working fluid; angle of a swash plate of the pump; or any combination thereof.

### CROSS REFERENCE TO RELATED APPLICATION

This application claims the benefit of Provisional Application No. 63/429,475, filed Dec. 1, 2022, which is incorporated by reference herein.

### TECHNICAL FIELD

The present disclosure generally relates to high pressure fluid systems, such as high pressure pumps and intensifiers. In particular, the present disclosure relates to systems and methods that change a rotational speed of a motor that powers a fluid pressurization system to compensate for fluctuating demand of pressurized working fluid output from the fluid pressurization system.

### BACKGROUND

### Description of the Related Art

Many industrial applications include the use of high pressure fluid. For example, processing (e.g., cutting) a workpiece with a waterjet uses high pressure water to generate the waterjet. Waterjet systems pressurize water to 15,000 psi or greater and convert that pressure to a fluid stream (i.e., a fluid jet) traveling at speeds in excess of Mach 2. This high velocity stream, often mixed with an abrasive, is capable of slicing through hard materials such as metal and granite with thicknesses of more than a foot.

Known systems include a pressure intensifier that is based on the piston principle, in which a larger diameter piston is pushed by a relatively low pressure fluid, and movement of the larger diameter piston results in movement of a smaller diameter piston. A pressurization fluid (e.g., hydraulic fluid, water, etc.) is cycled into and out of a first pressure chamber (e.g., via a pump) thereby exerting a force over an area of the larger diameter piston causing movement of the larger diameter piston and the smaller diameter piston, which is coupled to the larger diameter piston. The smaller diameter piston reciprocates within a second pressure chamber, and during a power stroke of the reciprocating movement, the smaller diameter piston compresses a working fluid (e.g., oil, water, etc.) within the second pressure cylinder to a relatively high pressure.

Some known pressure intensifiers used in waterjet systems operate with a ratio of the pressurization fluid to the pressurized working fluid between about 10 to 1 and about 40 to 1. For example, a 3,000 psi pressure applied to a larger diameter piston (e.g., via the pressurization fluid) results in an output pressure of 60,000 psi (for an intensifier ratio of 20 to 1) and an output pressure of 90,000 psi (for an intensifier ratio of 30 to 1).

Often the intensifier includes a hydraulic fluid system, in which the pressurization fluid is hydraulic fluid, and the hydraulic fluid is pumped into the intensifier to exert pressure on the larger diameter piston. The pressure of the hydraulic fluid moves the larger diameter piston, which is moveably coupled to the smaller diameter piston. Thus, movement of the larger diameter piston also moves the smaller diameter piston, thereby generating the pressurized working fluid.

The pressurized working fluid typically flows through a check valve body to an outlet check valve. If the pressure of the pressurized working fluid is greater than a biasing force provided by pressurized working fluid in an outlet area acting on a downstream end of the outlet check valve, the pressurized working fluid within the pressure vessel overcomes the biasing force, and passes through the outlet check valve to the outlet area. Typically, an intensifier has multiple cylinders, and pressurized working fluid from the outlet area of each cylinder is collected in an accumulator. Pressurized working fluid collected in this manner is then selectively used to perform a desired function, such as generating a fluid jet to process (e.g., cut) a workpiece.

Flow of the pressurized fluid is typically controlled by a pressurization pump (e.g., a hydraulic fluid pump). Known fluid pumps include a motor that is typically operated at a constant speed, and the pump includes a variable displacement mechanism (e.g., a swash plate) that is adjustable to increase/decrease a flow rate of the hydraulic fluid and thereby increase/decrease a volume of high pressure fluid output by the intensifier.

In applications such as a fluid jet cutting system, demand for the pressurized working fluid may fluctuate over time. These fluctuations may include instances of increased demand, decreased demand, no demand, or any combination thereof.

### BRIEF SUMMARY

When demand for pressurized working fluid in a high pressure system fluctuates, continuing to operate a pump that generates the pressurized working fluid at its “operating” or “working” speed, whether it be in a constant displacement or variable displacement style pump, may result in inefficiencies (e.g., wasted energy, unnecessary wear, etc.). Thus, it may be desirable to change the speed of the pump based on the fluctuating demand for the pressurized working fluid.

Additionally, it may be desirable to change the speed of the pump during “normal” operation of the high pressure system. According to one embodiment, pressurized working fluid may be generated by an intensifier (e.g., a double acting intensifier). The intensifier may generate pressurized working fluid during a power stroke (e.g., of a plunger within a pressure cylinder). As the plunger approaches the end of the power stroke, the plunger slows, then stops, and then reverses direction. During this process of changing direction, changing the operating speed of the pump (e.g., lowering the operating speed when the plunger has stopped, raising the operating speed as the plunger begins it recovery stroke) may result in improved efficiencies within the high pressure system.

According to one aspect of the disclosure, the high pressure system includes a fluid jet cutting system. The fluid jet cutting system has an intensifier that generates pressurized working fluid (e.g., water of at least 15,000 psi, water up to 90,000 psi) that is received by a cutting head of the fluid jet cutting system to generate a fluid jet. The generated fluid jet is used to process (e.g., cut) a workpiece. The fluid jet cutting system includes a pump that supplies pressurization fluid (e.g., hydraulic fluid) to the intensifier to generate the pressurized working fluid.

During operation of the fluid jet cutting system, demand for the pressurized working fluid fluctuates. For example, discharge of the fluid jet may be paused during movement of the cutting head. Additionally, discharge of the fluid jet may be paused when one workpiece is replaced (e.g., after processing of the one workpiece is complete) and another workpiece is positioned within an area of operation of the cutting head. Similarly, demand may decrease, but not completely pause/stop, during select portions of a processing operation. For example, a corner cutting operation may include a lower cutting speed and thus the cutting head may demand less pressurized working fluid. Demand may also fluctuate based on a changing material that is being processed by the fluid jet (e.g., with demand increasing when processing a harder material, and with demand decreasing when processing a softer material).

A decrease in demand for pressurized working fluid may be accompanied by a valve closure (e.g., at least a partial closure up to a complete closure), of a valve between one or more components of the high pressure system (e.g., the output of the intensifier and the cutting head). Closure of the valve may result in a decrease or stoppage in flow rate of the pressurized working fluid out of the intensifier, which may in turn result in one or more changes in operating parameters of the high pressure system.

According to one aspect of the disclosure, the one or more operating parameters that change as a result of a decrease or stoppage in demand for pressurized working fluid include: a reduction in flow rate of low pressure working fluid (e.g., water) that flows into a pressure chamber and is pressurized (e.g., by a smaller area piston of the intensifier) to become the pressurized working fluid that is output from the intensifier; a reduction in flow rate of pressurization fluid (e.g., hydraulic fluid) that enters the intensifier and exerts a pressure (e.g., against a larger area piston) to thereby pressurize the low pressure working fluid transitioning it into the pressurized working fluid; a change in angle of a swash plate coupled to an output shaft of a pump that pumps the pressurization fluid into and out of the intensifier; speed (e.g., RPM) of a motor that drives the pump; power and/or current drawn by the motor; or any combination thereof.

The present disclosure is directed to high pressure systems that include a fluid pump, and systems, components, and methods of changing an operating speed of the fluid pump in response to fluctuating demand for pressurized working fluid output by the high pressure system.

According to one embodiment, a fluid pressurization system includes a hydraulic pressure chamber, a piston positioned within an interior cavity of the hydraulic pressure chamber, a pump that conveys a hydraulic fluid into a portion of the interior cavity of the pressure chamber, wherein entry of the hydraulic fluid into the portion of the interior cavity moves the piston within the interior cavity. The fluid pressurization system further includes a motor coupled to the pump such that output from the motor drives the pump resulting in conveyance of the hydraulic fluid to the portion of the interior cavity, a hydraulic fluid flow rate sensor positioned to detect a change in flow rate of the hydraulic fluid, and generate a signal in response to the detected change, and a controller communicatively coupled to the hydraulic fluid flow rate sensor and to the motor such that the controller varies a rotational speed of the motor in response to receiving the signal generated in response to the detected change.

According to one embodiment, a fluid pressurization system includes a hydraulic pressure chamber, a piston, a pump, and a motor. The piston is positioned within an interior cavity of the hydraulic pressure chamber, and the pump conveys a hydraulic fluid into a portion of the interior cavity of the pressure chamber. Entry of the hydraulic fluid into the portion of the interior cavity moves the piston within the interior cavity. The motor is coupled to the pump such that output from the motor drives the pump resulting in conveyance of the hydraulic fluid to the portion of the interior cavity.

The fluid pressurization system further includes a working fluid pressure vessel, a working fluid flow rate sensor, and a controller. The working fluid pressure vessel is positioned relative to the hydraulic pressure chamber such that at least a portion of a plunger carried by the piston is positioned within a bore of the working fluid pressure vessel, such that movement of the piston within the interior cavity moves the plunger within the bore, thereby compressing a working fluid positioned within the bore. The working fluid flow rate sensor is positioned to detect a change in flow rate of the working fluid at a location upstream of the pressure vessel, and generate a signal in response to the detected change in working fluid flow rate. The controller is communicatively coupled to the working fluid flow rate sensor and to the motor such that the controller varies a rotational speed of the motor in response to receiving the signal generated in response to the detected change in flow rate.

According to one embodiment, a fluid pressurization system includes a hydraulic pressure chamber, a piston, a motor, a pump, and a controller. The piston is positioned within an interior cavity of the hydraulic pressure chamber. The motor includes an output shaft that rotates about an axis of rotation. The pump is coupled to the motor such that rotation of the output shaft conveys a hydraulic fluid into a portion of the interior cavity of the pressure chamber. The pump includes a swash plate oriented at an angle relative to the axis of rotation of the output shaft of the motor. Entry of the hydraulic fluid into the portion of the interior cavity moves the piston within the interior cavity. The controller is communicatively coupled to the motor such that the controller varies a rotational speed of the motor in response to receiving a signal generated in response to a detected change in the angle of the swash plate.

According to one embodiment, a method of operation of a fluid pressurization system includes operating a motor such that an output shaft rotates at a first rotational speed about an axis of rotation. The method further includes conveying hydraulic fluid to a portion of an interior cavity of a hydraulic pressure chamber via a pump coupled to the motor such that rotation of the output shaft drives the pump. The pump includes a swash plate oriented at an angle relative to the axis of rotation of the output shaft of the motor.

The method further includes moving a piston positioned within the interior cavity of the hydraulic pressure chamber via entry of the hydraulic fluid into the portion of the interior cavity, and pressurizing working fluid within a bore of a working fluid pressure vessel. The working fluid is pressurized via movement of a plunger carried by the piston such that movement of the piston within the interior cavity results in movement of the plunger within the bore. The method further includes generating a signal in response to a change in: a flow rate of the hydraulic fluid; a flow rate of the working fluid at a location upstream of the working fluid pressure vessel; the angle of the swash plate relative to the output shaft; or any combination thereof. The method further includes changing an operating speed of the motor such that the output shaft rotates at a second rotational speed that is different than the first rotational speed.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a view of an example fluid jet cutting system, according to one embodiment, which comprises a multi-axis manipulator (e.g., gantry motion system) supporting a cutting head assembly at a working end thereof for cutting workpieces.

FIG. 2 is a cross-sectional, side view of a fluid pressurization system according to one embodiment, showing a hydraulic piston at a first position within a hydraulic pressure chamber.

FIG. 3 is a cross-sectional, side view of the fluid pressurization system illustrated in FIG. 2, showing the hydraulic piston at a second position within the hydraulic pressure chamber.

FIG. 4 is a cross-sectional, side view of the fluid pressurization system illustrated in FIG. 2, showing the hydraulic piston at a third position within the hydraulic pressure chamber.

FIG. 5 is a schematic view of a fluid pressurization system according to one embodiment.

FIG. 6 is a schematic view of a motor and pump of the fluid pressurization system illustrated in FIG. 5, according to one embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

Reference herein to two elements “facing” or “facing toward” each other indicates that a straight line can be drawn from one of the elements to the other of the elements without contacting an intervening solid structure. The term “aligned” as used herein in reference to two elements along a direction means a straight line that passes through one of the elements and that is parallel to the direction will also pass through the other of the two elements. The term “between” as used herein in reference to a first element being between a second element and a third element with respect to a direction means that the first element is closer to the second element as measured along the direction than the third element is to the second element as measured along the direction. The term “between” includes, but does not require that the first, second, and third elements be aligned along the direction.

Recitation of ranges of values herein are merely intended to serve as a shorthand method of referring individually to each separate value falling within the range including the stated ends of the range, unless otherwise indicated herein, and each separate value is incorporated into the specification as if it were individually recited herein. All methods described herein can be performed in any suitable order unless otherwise indicated herein or otherwise clearly contradicted by context.

The headings and Abstract of the Disclosure provided herein are for convenience only and do not interpret the scope or meaning of the embodiments.

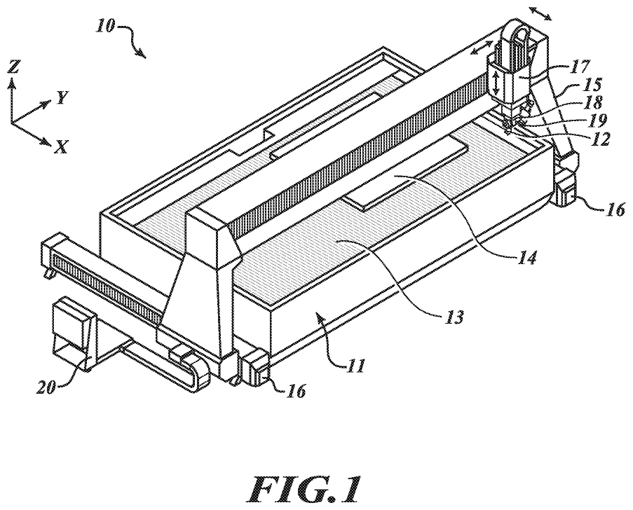

Referring to FIG. 1, an embodiment of a fluid jet cutting system 10 may include a catcher tank assembly 11 having a work support surface 13 (e.g., an arrangement of slats) that is configured to support a workpiece 14 to be processed by the system 10. The fluid jet cutting system 10 may further includes a bridge assembly 15 that is movable along a pair of base rails 16 and straddles the catcher tank assembly 11.

In operation, the bridge assembly 15 may be movable back and forth along the base rails 16 with respect to a translational axis X to position a cutting head assembly 12 of the system 10 for processing the workpiece 14. A tool carriage 17 may be movably coupled to the bridge assembly 15 to translate back and forth along another translational axis Y, which is aligned perpendicularly to the aforementioned translational axis X. The tool carriage 17 may be configured to raise and lower the cutting head assembly 12 along yet another translational axis Z to move the cutting head assembly 12 toward and away from the workpiece 14. One or more manipulable links or members may also be provided intermediate the cutting head assembly 12 and the tool carriage 17 to provide additional functionality.

As an example, the fluid jet cutting system 10 may include a robotic arm. The robotic arm may include a forearm 18 rotatably coupled to the tool carriage 17 for rotating the cutting head assembly 12 about an axis of rotation, and a wrist 19 rotatably coupled to the forearm 18 to rotate the cutting head assembly 12 about another axis of rotation that is non-parallel to the aforementioned rotational axis. In combination, the rotational axes of the forearm 18 and wrist 19 can enable the cutting head assembly 12 to be manipulated in a wide range of orientations relative to the workpiece 14 to facilitate, for example, cutting of complex profiles. The rotational axes may converge at a focal point which, in some embodiments, may be offset from the end or tip of a nozzle component of the cutting head assembly 12.

During operation, movement of the cutting head assembly 12 with respect to each of the translational axes and one or more rotational axes may be accomplished by various conventional drive components and an appropriate control system 20. The control system may generally include, without limitation, one or more computing devices, such as processors, microprocessors, digital signal processors (DSP), application-specific integrated circuits (ASIC), and the like.

To store information, the control system may also include one or more storage devices, such as volatile memory, non-volatile memory, read-only memory (ROM), random access memory (RAM), and the like. The storage devices can be coupled to the computing devices by one or more buses. The control system may further include one or more input devices (e.g., displays, keyboards, touchpads, controller modules, or any other peripheral devices for user input) and output devices (e.g., display screens, light indicators, and the like).

The control system can store one or more programs for processing any number of different workpieces according to various cutting head movement instructions. The control system may also control operation of other components, such as, for example, a secondary fluid source, a vacuum device and/or a pressurized gas source coupled to the waterjet cutting head assemblies and components described herein. The control system, according to one embodiment, may be provided in the form of a general-purpose computer system.

The computer system may include components such as a CPU, various I/O components, storage, and memory. The I/O components may include a display, a network connection, a computer-readable media drive, and other I/O devices (a keyboard, a mouse, speakers, etc.). A control system manager program may be executing in memory, such as under control of the CPU, and may include functionality related to, among other things, routing pressurized water through the waterjet cutting systems described herein, providing a flow of secondary fluid to adjust or modify the coherence of a discharged fluid jet and/or providing a pressurized gas stream to provide for unobstructed waterjet cutting of a workpiece.

Further example control methods and systems for waterjet cutting systems, which include, for example, CNC functionality, and which are applicable to the fluid jet cutting systems described herein, are described in U.S. Pat. No. 6,766,216. In general, computer-aided manufacturing (CAM) processes may be used to efficiently drive or control a cutting head along a designated path, such as by enabling two-dimensional or three-dimensional models of workpieces generated using computer-aided design (i.e., CAD models) to be used to generate code to drive the machines. For example, in some instances, a CAD model may be used to generate instructions to drive the appropriate controls and motors of a fluid jet cutting system to manipulate the cutting head about various translational and/or rotational axes to cut or process a workpiece as reflected in the CAD model.

Details of the control system, conventional drive components and other well-known systems associated with fluid jet cutting systems, however, are not shown or described in detail to avoid unnecessarily obscuring descriptions of the embodiments. Other known systems associated with fluid jet cutting systems include, for example, a pressurized fluid source (e.g., intensifier pumps with pressure ratings of at least 60,000 psi, at least 90,000 psi, or at least 110,000 psi) for supplying pressurized fluid to the cutting head.

According to some embodiments, the fluid jet cutting system 10 includes a pump, such as, for example, a direct drive pump or intensifier pump, to selectively provide a source of pressurized working fluid (e.g., water) at an operating pressure of at least 15,000 psi, at least 60,000 psi, at least 90,000 psi, or at least 110,000 psi. The cutting head assembly 12 of the fluid jet cutting system 10 is configured to receive the pressurized working fluid supplied by the pump and to generate a high pressure fluid jet for processing workpieces. A fluid distribution system in fluid communication with the pump and the cutting head assembly 12 may be provided to assist in routing pressurized working fluid from the pump to the cutting head assembly 12.

The fluid jet cutting system 10 is one example of an implementation for a fluid pressurizer or fluid pressurization as described herein. Other implementations for such a system include, but are not limited to, high pressure pascalization, slitters, or any other system or device that accepts high pressure working fluid as an input.

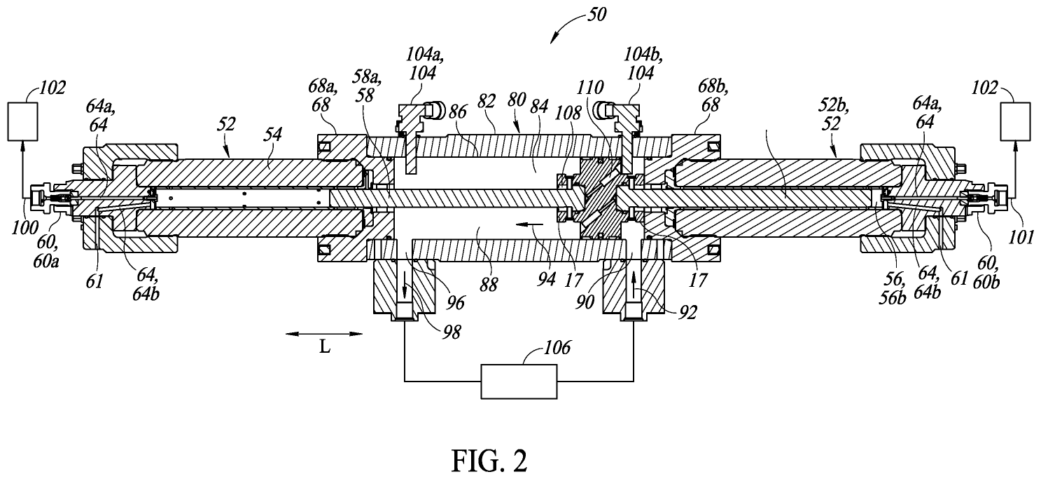

Referring to FIGS. 2 to 4, a fluid pressurizer 50 may include a pressure vessel 52 having a body 54 and a bore 56 extending through the pressure vessel 52 (e.g., along a length L of the pressure vessel 52). The fluid pressurizer 50 may include a plunger 58 that extends into the bore 56 through one end of the bore 56, and the fluid pressurizer 50 may include a check valve assembly 60 that extends into the bore 56 through the other, opposite along the length L, end of the bore 56. The plunger 58 may reciprocate within the pressure vessel 52 to pressurize a working fluid (e.g., water) in the bore 56. As shown, the plunger 58 may reciprocate along a direction that is parallel to the length L. The plunger 58 may be driven by a hydraulically actuated piston (e.g., a hydraulic piston 62) or alternatively by a mechanical actuator.

The check valve assembly 60 may include one or more check valves 64 (e.g., respective ones of the check valves 64 admitting unpressurized/low pressure working fluid into the pressure vessel 52, specifically the bore 56, during an intake stroke of the plunger 58, and allowing pressurized fluid to exit the pressure vessel 52 after a power stroke of the plunger 58). As shown, the fluid pressurizer 50 may include a working fluid inlet 61 through which unpressurized/low pressure working fluid enters the bore 56 of the pressure vessel 52 (e.g., during withdrawal of the plunger 58 from the bore 56).

The fluid pressurizer 50 may include an end cap 66 that secures the check valve assembly 60 in position relative to the pressure vessel 52. Similarly, the fluid pressurizer 50 may include a hydraulic head 68 securable relative to the pressure vessel 52 opposite the check valve assembly 60 and the end cap 66 along the length L.

The fluid pressurizer 50 may include seals between components of the fluid pressurizer 50 to prevent working fluid from leaking from the pressure vessel 52. For example, the fluid pressurizer 50 may include a dynamic seal 70 that forms a liquid impermeable barrier between the pressure vessel 52 and the hydraulic head 68. The fluid pressurizer 50 may include a static seal 72 that forms a liquid impermeable barrier between the pressure vessel 52 and the check valve assembly 60. The static seal 72 may include respective passages into the bore 56 for the check valves 64 of the check valve assembly 60. The fluid pressurizer 50 may include a sleeve 74 adjacent an inner wall 76 of the pressure vessel 52, the sleeve 74 being positioned so as to act as a buffer between the reciprocating plunger 58 and the body 54 of the pressure vessel 52.

The fluid pressurizer 50 may be double acting, (e.g., as shown in the illustrated embodiment). The double acting fluid pressurizer 50 may include a plurality of the plungers 58 and a plurality of pressure vessels 52, with respective ones of the plurality of the plungers 58 reciprocating within respective ones of the bores 56 of the plurality of pressure vessels 52. Alternatively, the fluid pressurizer 50 may be a single acting pump that includes only a single plunger 58 reciprocating within a bore 56 of a single pressure vessel 52.

As shown, the fluid pressurizer 50 may include a hydraulic pressure chamber 80. The hydraulic pressure chamber 80 may include a chamber body 82 and a bore 84 extending through the chamber body 82. As shown, the bore 84 may extend through the chamber body 82 along a length of the hydraulic pressure chamber 80, and the length of the hydraulic pressure chamber 80 may be parallel to the length L of the pressure vessel 52 when the hydraulic pressure chamber 80 is secured to the pressure vessel 52. An inner surface 86 of the hydraulic pressure chamber 80 may face the bore 84 and form an interior cavity 88 of the hydraulic pressure chamber 80.

The hydraulic pressure chamber 80 may include a first port 90 that provides passage for a pressurization fluid (e.g., hydraulic fluid/oil) to enter interior cavity 88. As shown in FIG. 2, an amount of the pressurization fluid may enter (e.g., be pumped into) the interior cavity 88 in the direction indicated by arrow 92. As the amount of the pressurization fluid that enters the interior cavity 88 increases, the hydraulic piston 62 may be forced to move (e.g., translate within the interior cavity 88). As shown, the pressurization fluid may enter the first port 90, which may be positioned to one side (e.g., the right side as illustrated) of the hydraulic piston 62. As the pressurization fluid enters the first port 90, the pressurization fluid pushes the hydraulic piston 62 (e.g., to the left as indicated by arrow 94).

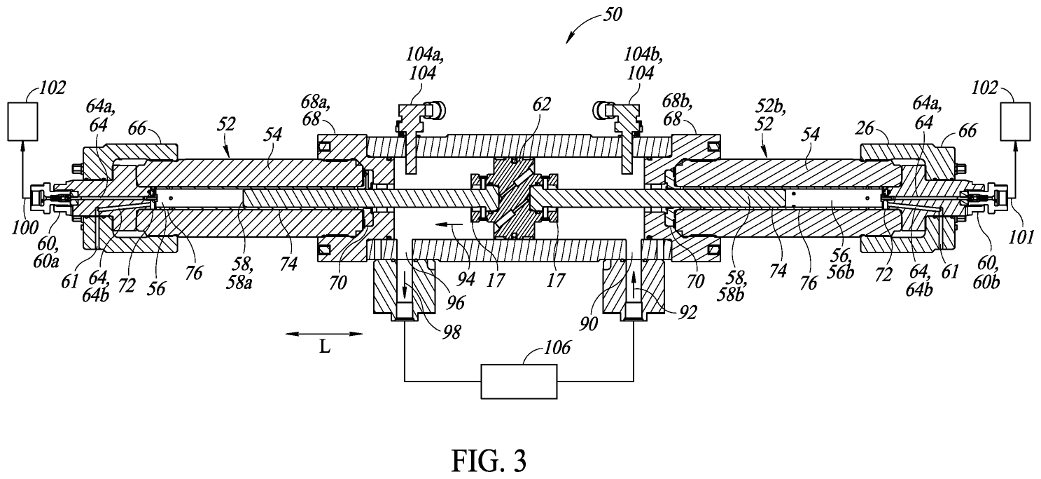

The hydraulic pressure chamber 80 may include a second port 96 that provides passage for the pressurization fluid to exit the interior cavity 88. As shown in FIG. 3, an amount of the pressurization fluid may exit (e.g., be pushed out of) the interior cavity 88 via the second port 96 in the direction indicated by arrow 98. The fluid pressurizer 50 may include seals between components of the fluid pressurizer 50 to prevent hydraulic fluid from leaking (e.g., from the hydraulic pressure chamber 80).

The plunger 58 (e.g., a first plunger 58a) may be carried by the hydraulic piston 62 such that movement of the hydraulic piston 62 results in corresponding movement of the first plunger 58a. As shown, the first plunger 58a may pass through the bore 56 (e.g., a first bore 56a) of the pressure vessel 52 (e.g., a first pressure vessel 52a). As the first plunger 58a advances within the first bore 56a, the working fluid (e.g., water) within the first bore 56a is pressurized and exits via one of the check valves 64 (e.g., a first check valve 64a) of the check valve assembly 60 (e.g., a first check valve assembly 60a). The pressurized working fluid may then exit the fluid pressurizer 50 (e.g., as indicated by arrow 100) and be delivered to a system 102 (e.g., a fluid jet cutting head) that uses the pressurized fluid (e.g., to form a fluid jet that processes a workpiece).

In the embodiment in which the fluid pressurizer 50 is a double acting pump, a second plunger 58b may be carried by the hydraulic piston 62 such that movement of the hydraulic piston 62 results in corresponding movement of the second plunger 58b. As shown, the second plunger 58b may withdraw through a second bore 56b of a second pressure vessel 52b). As the second plunger 58b withdraws through the second bore 56b, unpressurized/low pressure working fluid (e.g., water) enters the second bore 56b via one of the check valves 64 (e.g., a second check valve 64b) of the check valve assembly 60 (e.g., a second check valve assembly 60b). As shown, the second check valve 64b may be fluidly coupled to one of the working fluid inlets 61.

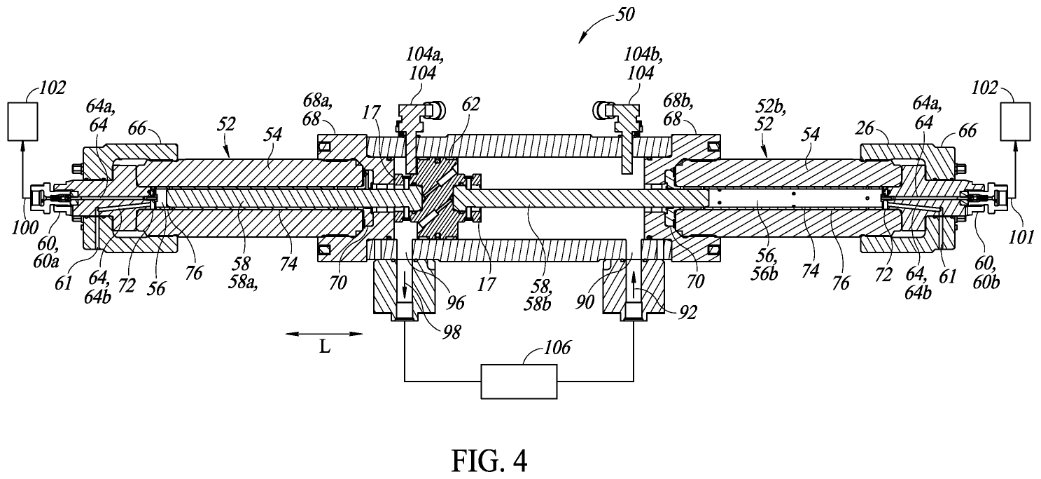

The fluid pressurizer 50 may include a proximity sensor 104 that senses the hydraulic piston 62 as the hydraulic piston 62 approaches the end of a stroke (e.g., a power stroke for the first pressure vessel 52a as shown in FIG. 4). According to one embodiment, when the proximity sensor 104 senses the arrival of the hydraulic piston 62 the fluid pressurizer 50 changes (e.g., reverses) the direction of movement of the hydraulic piston 62. According to one embodiment, the fluid pressurizer 50 includes a direction control valve 106 that changes the direction of flow of the hydraulic fluid. For example, during the power stroke of the first pressure vessel 52a, the hydraulic fluid may enter the first port 90 (e.g., into a first portion of the interior cavity 88 that is “behind” the hydraulic piston 62 with respect to the direction of movement of the hydraulic piston 62).

As the hydraulic piston 62 approaches the end of the power stroke for the first pressure vessel 52a, the proximity sensor 104 (e.g., a first proximity sensor 104a) may detect the hydraulic piston 62 and trigger the direction control valve 106 to change the direction of flow of the pressurization fluid (e.g., to enter via the second port 96 into a second portion of the interior cavity 88 that is “in front of” the hydraulic piston 62 with respect to the direction of movement of the hydraulic piston 62 during the power stroke of the first pressure vessel 52a). As shown, the hydraulic head 68, for example a first hydraulic head 68a may be positioned between the first pressure vessel 52a and the hydraulic pressure chamber 80.

The hydraulic piston 62 may include one or more check valves 110 that provide passage for pressurization fluid within the pocket 108 to pass through a portion of the hydraulic piston 62 and exit into a portion of the interior cavity 88 opposite the pocket 108 (i.e., the portion of the interior cavity 88 that is “behind” the hydraulic piston 62 with respect to its direction of movement), or the portion of the interior cavity 88 between the hydraulic piston 62 and a second hydraulic head 68b. The hydraulic piston 62, according to one embodiment, may be devoid of the check valve 110.

After the change in direction of the hydraulic piston 62 is complete (i.e., such that the hydraulic piston 62 travels away from the first hydraulic head 68a and the first pressure vessel 52a, and (when the fluid pressurizer 50 is a double acting pump) travels towards the second hydraulic head 68b and the second pressure vessel 52b. As the hydraulic piston 62 travels away from the first hydraulic head 68a (or the hydraulic head 68 when the fluid pressurizer 50 is a single acting pump), the first plunger 58a withdraws from the first bore 56a of the first pressure vessel 52a.

During the withdrawal of the first plunger 58a from the first pressure vessel 52a, unpressurized/low pressure working fluid (e.g., water) may enter the first bore 56a (e.g., via the second check valve 64b of the first check valve assembly 60a). As shown, the second check valve 64b of the first check valve assembly 60a may be fluidly coupled to one of the working fluid inlets 61. As the hydraulic piston 62 advances towards the second pressure vessel 52b, the second plunger 58b advances within the second bore 56b thereby pressurizing the working fluid (e.g., water) within the second bore 56b. The pressurized working fluid exits the second pressure vessel 52b via one of the check valves 64 (e.g., the first check valve 64a) of the second check valve assembly 60b. The pressurized fluid may then exit the fluid pressurizer 50 (e.g., as indicated by arrow 101) and be delivered to a system (e.g., the system 102) that uses the pressurized working fluid.

The fluid pressurizer 50 may include a second proximity sensor 104b that senses the hydraulic piston 62 as the hydraulic piston 62 approaches the end of a stroke (e.g., a power stroke for the second pressure vessel 52b as shown in FIG. 2). According to one embodiment, when the second proximity sensor 104b senses the arrival of the hydraulic piston 62 the fluid pressurizer 50 changes (e.g., reverses) the direction of movement of the hydraulic piston 62 (e.g., via the direction control valve 106).

For example, during the power stroke of the second pressure vessel 52b, the pressurization fluid may enter the second port 96 (e.g., into the second portion of the interior cavity 88 that is “behind” the hydraulic piston 62 with respect to the direction of movement of the hydraulic piston 62). As the hydraulic piston 62 approaches the end of the power stroke for the second pressure vessel 52b, the second proximity sensor 104b may detect the hydraulic piston 62 and trigger the direction control valve 106 to change the direction of flow of the hydraulic fluid (e.g., to enter via the first port 90 into the first portion of the interior cavity 88 that is “in front of” the hydraulic piston 62 with respect to the direction of movement of the hydraulic piston 62 during the power stroke of the second pressure vessel 52b).

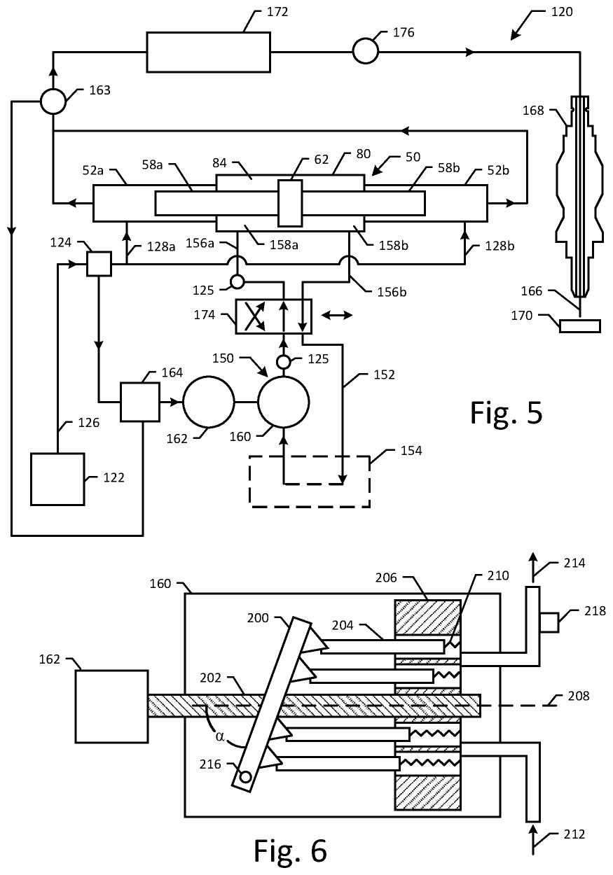

Referring to FIG. 5, a high pressure system 120 (e.g., a fluid pressurization system) may include a source of working fluid 122. According to one embodiment, the source of working fluid 122 is a tank holding a volume of water (or some other working fluid). The fluid source of working fluid 122 may be fluidly coupled to a fluid pressurizer (e.g., the fluid pressurizer 50). The high pressure system 120 may include a flow rate sensor 124 (e.g., a working fluid flow rate sensor) positioned between the source of working fluid 122 and the fluid pressurizer 50 such that the flow rate sensor 124 measures a flow rate of the working fluid from the source of working fluid 122 to the fluid pressurizer 50 (e.g., at a location upstream of the fluid pressurizer 50).

The fluid pressurizer 50 may be a double acting intensifier, and a path 126 from the source of working fluid 122 to the fluid pressurizer 50 may split (e.g., with one branch 128a being coupled to the first pressure vessel 52a and another branch 128b being coupled to the second pressure vessel 52b). As shown, the flow rate sensor 124 may be positioned along the path 126 at a location between the source of working fluid 122 and where the path 126 splits into multiple branches (e.g., the branches 128a and 128b). According to another embodiment, the high pressure system 120 may include multiple flow rate sensors 124. The multiple flow rate sensors 124 may include at least one flow rate sensor 124 on each of the multiple branches (e.g., the branches 128a and 128b) positioned between the path 126 split and the fluid pressurizer 50. Although the fluid pressurizer 50 shown in the illustrated embodiment is a double acting intensifier, the high pressure system 120 may instead include other fluid pressurization mechanisms (e.g., a single acting intensifier, etc.).

The high pressure system 120 may include a pressurization system (e.g., a hydraulic system 150). According to one embodiment, the hydraulic system 150 may include a pressurization fluid path 152. As shown, the pressurization fluid path 152 may fluidly connect a pressurization fluid vessel 154 to the fluid pressurizer 50 (e.g., the bore 84 of the hydraulic pressure chamber 80). According to one embodiment of the high pressure system 120 in which the fluid pressurizer 50 is a double acting intensifier, the pressurization fluid path 152 may include a first branch 156a that connects the pressurization fluid vessel 154 to a first portion 158a of the bore 84, and the pressurization fluid path 152 may include a second branch 156b that connects the pressurization fluid vessel 154 to a second portion 158b of the bore 84. As shown the first portion 158a and the second portion 158b may be separated by the piston 62. The hydraulic system 150, according to one embodiment, may be devoid of the pressurization fluid vessel 154 and the first branch 156a may be directly coupled to the second branch 156b.

The hydraulic system 150 may include a pump 160 that generates flow of the pressurization fluid along the pressurization fluid path 152. The hydraulic system 150 may include a motor 162 that drives the pump 160. The hydraulic system 150 may include a controller 164 that controls performance (e.g., rotational speed) of the motor 162. When the high pressure system 120 has a demand for pressurized working fluid (e.g., to be converted into a fluid jet 166 by a fluid jet cutting head 168 to process a workpiece 170), the pump 160 pumps pressurization fluid (e.g., hydraulic fluid) into the bore 84 (e.g., the first portion 158a of the bore 84) of the hydraulic pressure chamber 80.

The pressurization fluid exerts a pressure (e.g., between about 1,000 psi and about 5,000 psi) against the piston 62. This pressure moves the piston 62 and a plunger (e.g., the second plunger 58b) into a pressure vessel (e.g., the second pressure vessel 52b). Working fluid present within the second pressure vessel 52b is pressurized as the second plunger 58b advances. The piston 62 includes an area upon which the pressurization fluid acts, and the second plunger 58b includes an area that acts upon the working fluid within the second pressure vessel 52b. The area of the piston 62 may be larger than the area of the second plunger 58b, thereby resulting in a mechanical advantage.

According to one embodiment, the pressurization fluid within the first portion 158a of the bore 84 is between about 2,000 psi and about 3,000 psi, and the area of the piston 62 upon which the pressurization fluid acts is between about 20 and about 30 times the area of the second plunger 58b that acts upon the working fluid. This results in the working fluid being pressurized to between about 40,000 psi and about 90,000 psi. Other pressurization fluid pressures and piston/plunger ratios may be employed by the high pressure system 120 to result in other desired pressures for the pressurized working fluid. The pressurized working fluid may exit the fluid pressurizer 50 and be carried to an accumulator 172 or directly to a component (e.g., the fluid jet cutting head 168) that is producing the demand for the pressurized working fluid.

As the pressurization fluid enters the first portion 158a and exerts pressure against the piston 62, thereby moving the piston 62 and decreasing a size of the second portion 158b, pressurization fluid within the second portion 158b exits the bore 84 of the hydraulic pressure chamber 80. The pressurization fluid may exit the bore 84 and travel along the second branch 156b of the pressurization fluid path 152 to the pressurization fluid vessel 154. Pressurization fluid may be drawn from the pressurization fluid vessel 154 (e.g., via the pump 160) and travel along the first branch 156a to the first portion 158a of the bore 84.

Upon completion of a power stroke into the second pressure vessel 52b, the process may reverse. Movement of the piston 62 toward the second pressure vessel 52b may stop. The pressurization fluid path 152 may change so that the pump 160 pumps pressurization fluid into the second portion 158b of the bore 84 of the hydraulic pressure chamber 80. The hydraulic system 150 may include at least one switcher 174 that reroutes the flow of pressurization fluid from the pump 160 to the second portion 158b and from the first portion 158a to the pressurization fluid vessel 154. The switcher 174 may include one or more valves that open/close to reroute the flow of pressurization fluid as described.

The high pressure system 120 may include a pressurization fluid flow rate sensor 125 (e.g., a hydraulic fluid flow rate sensor) positioned between components of the pressurization system such that the pressurization fluid flow rate sensor 125 measures a flow rate of the pressurization (e.g., hydraulic) fluid. According to one embodiment, the pressurization fluid flow rate sensor 125 may be positioned between the pump 160 and the switcher 174. According to one embodiment, the pressurization fluid flow rate sensor 125 may be positioned between the switcher 174 and the hydraulic pressure chamber 80. According to one embodiment, the pressurization fluid flow rate sensor 125 may be positioned between the switcher 174 and the pressurization fluid vessel 154. According to one embodiment, the pressurization fluid flow rate sensor 125 may be positioned between the pressurization fluid vessel 154 and the pump 160. The high pressure system 120 may include a plurality of pressurization fluid flow rate sensors 125 positioned at various locations (e.g., including one or more of the locations described above).

The pressurization fluid may exert a pressure against the piston 62 (e.g., the right side of the piston as shown). This pressure moves the piston 62 and a plunger (e.g., the first plunger 58a) into a pressure vessel (e.g., the first pressure vessel 52a). Working fluid present within the first pressure vessel 52a is pressurized as the first plunger 58a advances. The piston 62 includes an area upon which the pressurization fluid acts, and the first plunger 58a includes an area that acts upon the working fluid within the first pressure vessel 52a. The piston/plunger ratio may be the same as described above in reference to the piston 62 and the second plunger 58b.

The pressurized working fluid may exit the fluid pressurizer 50 and be carried to the accumulator 172 or directly to the component (e.g., the fluid jet cutting head 168) that is producing the demand for the pressurized working fluid. As the pressurization fluid enters the second portion 158b and exerts pressure against the piston 62, thereby moving the piston 62 and decreasing a size of the first portion 158a, pressurization fluid within the first portion 158a exits the bore 84 of the hydraulic pressure chamber 80. The pressurization fluid may exit the bore 84 and travel along the first branch 156a of the pressurization fluid path 152 to the pressurization fluid vessel 154. Pressurization fluid may be drawn from the pressurization fluid vessel 154 (e.g., via the pump 160) and travel along the second branch 156b to the second portion 158b of the bore 84.

The high pressure system 120 may include one or more valves 176 that transition from an open configuration (in which fluid flows through the valve 176) to a closed configuration (in which fluid flow through the valve 176 is blocked). As shown, one of the valves 176 may be positioned downstream of the fluid pressurizer 50 (e.g., between the fluid pressurizer 50 and the accumulator 172, between the fluid pressurizer 50 and the fluid jet cutting head 168, between the accumulator 172 and the fluid jet cutting head 168, or any combination thereof).

Fluctuating demand for pressurized working fluid may result in transitioning of the one or more valves 176. For example, a drop in demand for pressurized working fluid may result in closure of the valve 176. Closure of the valve 176 may block additional pressurized working fluid from exiting the fluid pressurizer 50, which may in turn prevent entry of unpressurized/low pressure working fluid (e.g., about 15 psi to about 250 psi) into the fluid pressurizer 50. During a reduced demand for pressurized working fluid, changing operating parameters of the pump 160 may result in increased efficiency.

Referring to FIG. 6, the pump 160 may include a swash plate 200 that translates rotational motion of an output shaft 202 of the motor 162 into reciprocating motion of one or more pistons 204. The swash plate 200 may be stationary (e.g., non-rotating) relative to the rotating output shaft 202. The pump 160 may include a piston block 206 that carries a number of the pistons 204. A first end of the pistons 204 may abut the swash plate 200 which is oriented at an angle α relative to the output shaft 202 (e.g., an axis 208 about which the output shaft 202 rotates).

The piston block 206 may be rotationally coupled to the output shaft 202 such that as the output shaft 202 rotates the piston block 206 rotates simultaneously. As the piston block 206 rotates, the pistons 204 push against the stationary swash plate 200 resulting in a reciprocal motion of each of the pistons 204 within a respective cylinder within the piston block 206. A second end of the pistons 204 may be coupled to a biasing member 210 (e.g., a spring) that couples the piston 204 to the piston block 206.

During one half of a revolution about the axis 208, while the piston 204 withdraws from the piston block 206, the piston 204 may generate a vacuum that draws pressurization fluid into the piston block 206 (e.g., from the pressurization fluid vessel 154 as indicated by arrow 212). During the other half of the revolution about the axis 208, while the piston 204 enters into the piston block 206, the piston 204 expels pressurization fluid from the piston block 206 (e.g., out of the pump 160 and toward the fluid pressurizer 50 as indicated by arrow 214).

The smaller the angle α of the swash plate 200, the higher the flow rate of pressurization fluid transferred during a revolution about the axis 208. When the angle α of the swash plate 200 is 90 degrees, the flow rate of pressurization fluid transferred during a revolution about the axis 208 is zero, or close to zero (e.g., there may be a minimal amount of flow sufficient to maintain lubrication of the components of the pump 160).

The pump 160 may be optimized such that performance of the pump 160 is best when the angle α of the swash plate 200 is within a select range. According to one embodiment, the select range for the angle α of the swash plate 200 of the pump 160 is between 70 degrees and 80 degrees. According to one embodiment, the select range for the angle α of the swash plate 200 of the pump 160 is between 65 degrees and 85 degrees. Thus, while it is known that changing the angle α of the swash plate 200 results in a change of flow rate (i.e., output) for the pump 160, it may be beneficial to maintain the angle α of the swash plate 200 within the select range at all times (or as often as possible).

Thus, according to one embodiment, the pump 160 is operable to maintain the angle α of the swash plate 200 while changing the rotational speed of the output shaft 202 and the piston block 206. Lowering the rotational speed of the motor 162, while maintaining the angle α of the swash plate 200 within the select range, will result in a decreasing flow rate while maintaining optimal operating parameters (e.g., the angle α of the swash plate 200 within the select range) of the pump 160.

Referring to FIGS. 5 and 6, the motor 162 may be communicatively coupled to the flow rate sensor 124 (e.g., via the controller 164). The flow rate sensor 124, upon detecting a change in flow rate of the unpressurized/low pressure working fluid, generates a signal that results in a corresponding change in rotational speed of the motor 162. According to one embodiment, upon a decrease in demand for pressurized working fluid, the valve 176 may close, thereby reducing (e.g., stopping) flow of pressurized working fluid out of the fluid pressurizer 50. This reduction, in turn, reduces (e.g., stops) flow of unpressurized/low pressure working fluid into the fluid pressurizer 50.

Upon detecting the reduced flow rate of the unpressurized/low pressure working fluid, the flow rate sensor 124 sends a signal to the controller 164. Upon receipt of the signal from the flow rate sensor 124, the controller 164 lowers the rotational speed of the motor 162, thereby reducing the flow rate of the pressurization fluid through the pump 160. According to one embodiment, the swash plate 200 remains within the select range during the change in speed of the motor 162.

According to one embodiment, upon an increase in demand for pressurized working fluid, the valve 176 may open, thereby increasing flow of pressurized working fluid out of the fluid pressurizer 50. This increase, in turn, increases flow of unpressurized/low pressure working fluid into the fluid pressurizer 50. Upon detecting the increased flow rate of the unpressurized/low pressure working fluid, the flow rate sensor 124 sends a signal to the controller 164. Upon receipt of the signal from the flow rate sensor 124, the controller 164 increases the rotational speed of the motor 162, thereby increasing the flow rate of the pressurization fluid through the pump 160. According to one embodiment, the swash plate 200 remains within the select range during the change in speed of the motor 162.

According to one embodiment, upon a change in demand for pressurized working fluid, the angle α of the swash plate 200 may change (e.g., in response to decreased flow rate of pressurized working fluid exiting the fluid pressurizer 50, which results in decreased flow rate of pressurization fluid within the pressurization fluid path 152. A decrease in demand for pressurized working fluid may result in the angle α of the swash plate 200 increasing (approaching 90 degrees), while remaining within the select range. An increase in demand for pressurized working fluid may result in the angle α of the swash plate 200 decreasing (retreating from 90 degrees), while remaining within the select range.

The high pressure system 120 (e.g., the pump 160) may include a swash plate angle sensor 216 that measures the angle α of the swash plate 200. Upon detecting a change in the angle α of the swash plate 200, the swash plate angle sensor 216 may send a signal (e.g., to the controller 164) that changes the rotational speed of the motor 162. Upon detecting an increase in the angle α of the swash plate 200, the swash plate angle sensor 216 may send a signal to the controller 164. Upon receipt of the signal from the flow rate sensor 124, the controller 164 decreases the rotational speed of the motor 162, thereby decreasing the flow rate of the pressurization fluid through the pump 160. Upon detecting a decrease in the angle α of the swash plate 200, the swash plate angle sensor 216 may send a signal to the controller 164. Upon receipt of the signal from the flow rate sensor 124, the controller 164 increases the rotational speed of the motor 162, thereby increasing the flow rate of the pressurization fluid through the pump 160.

According to one embodiment, the high pressure system 120 may calculate the angle α of the swash plate 200 based on other operational parameters (e.g., the flow rate(s) of the unpressurized/low pressure working fluid and/or the hydraulic fluid, the rotational speed “RPM” of or the current/amps drawn by the motor 162). Thus, the angle α of the swash plate 200 may be monitored for change without the swash plate angle sensor 216, and the high pressure system 120 may be devoid of a swash plate angle sensor.

The high pressure system 120 (e.g., the pump 160) may include a pressurization fluid flow rate sensor 218 that measures the flow rate of pressurization fluid (e.g., hydraulic oil) along the pressurization fluid path 152 (e.g., exiting the pump 160). Upon detecting a change in the flow rate of the pressurization fluid, the pressurization fluid flow rate sensor 218 may send a signal (e.g., to the controller 164) that changes the rotational speed of the motor 162.

Upon detecting an increase in pressurization fluid flow rate (e.g., via the pressurization fluid flow rate sensor 218), the controller 164 may increase the rotational speed of the motor 162, thereby increasing the flow rate of the pressurization fluid through the pump 160. Upon detecting a decrease in the pressurization fluid flow rate (e.g., via the pressurization fluid flow rate sensor 218), the controller 164 may decrease the rotational speed of the motor 162, thereby decreasing the flow rate of the pressurization fluid through the pump 160.

According to one embodiment, the high pressure system 120 may calculate the flow rate of the pressurization fluid based on other operational parameters (e.g., the angle α of the swash plate and the rotational speed “RPM” of or the current drawn by the motor 162). Thus, the pressurization fluid flow rate may be monitored for change without the pressurization fluid flow rate sensor 218, and the high pressure system 120 may be devoid of a pressurization fluid flow rate sensor.

Changing the rotational speed of the motor 162 based on determined (e.g., measured, calculated, or predicted) operational parameters other than pressure (e.g., of the pressurization and/or working fluid) may result in a reduction in lag time between a fluctuation in demand for the pressurized working fluid and a corresponding change in speed of the motor 162.

Some embodiments of the high pressure system 120 may include additional sensors. For example, the high pressure system 120 may include one or more sensors 163 (e.g., a flow rate sensor) positioned along a path of the pressurized working fluid downstream of the fluid pressurizer 50 (e.g., between the fluid pressurizer 50 and the accumulator 172, between the accumulator 172 and the one or more valves 176, or downstream of the one or more valves 176). The one or more sensors 163 may measure a flow rate of the pressurized working fluid. The one or more sensors 163 may be communicatively coupled to the motor 162 (e.g., via the controller 164).

The one or more sensors 163, upon detecting a change in flow rate of the pressurized working fluid, generate a signal that results in a corresponding change in rotational speed of the motor 162. According to one embodiment, the one or more sensors 163 may (e.g., upon detecting a problem/issue with the supply/demand for the pressurized working fluid) increase the speed of the motor (e.g., to its full speed). Upon detecting the problem/issue, the one or more sensors 163 may effectively disable the controller 164, so that the motor 162 operates at a fixed speed, until the problem/issue is resolved. Other embodiments of the high pressure system 120 may be devoid of the one or more sensors 163.

Referring to FIGS. 1 to 6, a method of operation of a high pressure system (e.g., the high pressure system 120) may include operating a motor (e.g., the motor 162) at a first speed. The method may further include pumping a pressurization fluid (e.g., hydraulic oil) into a portion (e.g., the first portion 158a) of a fluid pressurizer (e.g., the hydraulic pressure chamber 80 of the fluid pressurizer 50) at a first flow rate. The first flow rate may correspond to an angle of a swash plate (e.g., the angle α of the swash plate 200) of the pump.

The first flow rate of the pressurization fluid may correspond to the operating speed of the motor 162, such that increasing the operating speed increases the first flow rate, and vice versa. According to one embodiment, the first speed of the motor 162 corresponds to a rotational speed of an output shaft (e.g., the output shaft 202), and the rotational speed of the output shaft corresponds to the first flow rate.

The method may further include pumping unpressurized/low pressure working fluid into at least one pressure chamber (e.g., the pressure vessel 52) of a fluid pressurizer (e.g., the fluid pressurizer 50) at a second flow rate. The method may further include pressurizing the working fluid within the pressure chamber to generate pressurized working fluid (e.g., between 15,000 psi and 90,000 psi). According to one embodiment, pumping the pressurization fluid into a portion of the hydraulic pressure chamber 80 moves a compression member (e.g., the piston 62 and one or more plungers 58), wherein the pressurization fluid acts upon a first surface of the compression member and the working fluid is pressurized by a second surface of the compression member, which has a smaller area than the first surface. According to one embodiment, the compression member (e.g., the piston 62 and one or more plungers 58 may be a monolithic, one-piece construction).

The method may further include supplying the pressurized working fluid to a component (e.g., the cutting head 168) with a demand for the pressurized working fluid. The method may further include identifying a change in: the first flow rate; the second flow rate; the angle of the swash plate; or any combination thereof. Identifying the change(s) may include direct identification of the change(s) (e.g., by one or more sensors, such as the flow rate sensor 124, the pressurization fluid flow rate sensor 218, the swash plate angle sensor 216). Alternatively, or in addition to direct identification, identifying the change(s) may include indirect identification of the change(s) (e.g., by calculating the change(s) based on one or more other parameters of the high pressure system 120).

According to one embodiment, the change(s) in: the first flow rate; the second flow rate; the angle of the swash plate; or any combination thereof occur without user intervention (i.e., they are an automatic response to a fluctuating demand for pressurized working fluid by the component). The method may include, based on an identification of the change(s), changing the operating speed of the motor.

According to one embodiment, identifying the change may include identifying: a decrease in the first flow rate; a decrease in the second flow rate; an increase in the angle of the swash plate; or any combination thereof, and changing the operating speed of the motor includes lowering the operating speed of the motor. According to one embodiment, identifying the change may include identifying: an increase in the first flow rate; an increase in the second flow rate; a decrease in the angle of the swash plate; or any combination thereof, and changing the operating speed of the motor includes increasing the operating speed of the motor.

In general, in the following claims, the terms used should not be construed to limit the claims to the specific implementations and embodiments disclosed in the specification and the claims, but should be construed to include all possible implementations and embodiments along with the full scope of equivalents to which such claims are entitled. Accordingly, the claims are not limited by the disclosure.

1. A fluid pressurization system comprising:
a hydraulic pressure chamber;
a piston positioned within an interior cavity of the hydraulic pressure chamber;
a pump that conveys a hydraulic fluid into a portion of the interior cavity of the pressure chamber, wherein entry of the hydraulic fluid into the portion of the interior cavity moves the piston within the interior cavity;
a motor coupled to the pump such that output from the motor drives the pump resulting in conveyance of the hydraulic fluid to the portion of the interior cavity;
a hydraulic fluid flow rate sensor positioned to detect a change in flow rate of the hydraulic fluid, and generate a signal in response to the detected change; and
a controller communicatively coupled to the hydraulic fluid flow rate sensor and to the motor such that the controller varies a rotational speed of the motor in response to receiving the signal generated in response to the detected change.

2. The fluid pressurization system of claim 1, further comprising:
a working fluid pressure vessel positioned relative to the hydraulic pressure chamber such that at least a portion of a plunger carried by the piston is positioned within a bore of the working fluid pressure vessel,
wherein movement of the piston within the interior cavity moves the plunger within the bore, thereby compressing a working fluid positioned within the bore.

3. The fluid pressurization system of claim 2, further comprising:
a working fluid flow rate sensor positioned to detect a change in flow rate of the working fluid at a location upstream of the pressure vessel, and generate a signal in response to the detected change in working fluid flow rate.

4. The fluid pressurization system of claim 3 wherein the controller is communicatively coupled to the working fluid flow rate sensor such that the controller varies the rotational speed of the motor in response to receiving the signal generated by the working fluid flow rate sensor.

5. The fluid pressurization system of claim 2 wherein the hydraulic fluid acts upon a surface of the piston with a first area, the plunger includes a surface that acts upon the working fluid, the surface of the plunger having a second area, and the first area is larger than then second area.

6. The fluid pressurization system of claim 5 wherein a ratio of the first area to the second area is within a range of greater than or equal to 10 to 1 and less than or equal to 40 to 1.

7. The fluid pressurization system of claim 1 wherein the portion of the interior cavity is a first portion, and the fluid pressurization system further comprises:
a second portion of the interior cavity,
wherein movement of the piston in a first direction within the interior cavity expels hydraulic fluid from the second portion.

8. The fluid pressurization system of claim 7, further comprising:
a switcher that transitions from a first configuration, in which the pump conveys the hydraulic fluid into the first portion of the interior cavity, to a second configuration, in which the pump conveys the hydraulic fluid into the second portion of the interior cavity,
wherein entry of the hydraulic fluid into the second portion of the interior cavity moves the piston in a second direction within the interior cavity that is opposite the first direction.

9. The fluid pressurization system of claim 8 wherein the hydraulic fluid flow rate sensor is positioned between the pump and the hydraulic pressure chamber.

10. The fluid pressurization system of claim 9 wherein the hydraulic fluid flow rate sensor is positioned between the pump and the switcher.

11. The fluid pressurization system of claim 1 wherein the hydraulic fluid flow rate sensor is positioned between the pump and the hydraulic pressure chamber.

12. The fluid pressurization system of claim 1 wherein the pump includes a swash plate oriented at an angle relative to an axis of rotation of an output shaft of the motor, the output shaft rotatable relative to the swash plate about the axis,
wherein the controller, in response to a change in the angle of the swash plate, varies the rotational speed of the motor.

13. The fluid pressurization system of claim 12, further comprising:
a swash plate sensor that detects a change in the angle of the swash plate, and that generates a signal in response to the detected change,
wherein the controller is communicatively coupled to the swash plate sensor such that the controller varies the rotational speed of the motor in response to receiving the signal generated by the swash plate sensor.

14. A fluid pressurization system comprising:
a hydraulic pressure chamber;
a piston positioned within an interior cavity of the hydraulic pressure chamber;
a pump that conveys a hydraulic fluid into a portion of the interior cavity of the pressure chamber, wherein entry of the hydraulic fluid into the portion of the interior cavity moves the piston within the interior cavity;
a motor coupled to the pump such that output from the motor drives the pump resulting in conveyance of the hydraulic fluid to the portion of the interior cavity;
a working fluid pressure vessel positioned relative to the hydraulic pressure chamber such that at least a portion of a plunger carried by the piston is positioned within a bore of the working fluid pressure vessel, wherein movement of the piston within the interior cavity moves the plunger within the bore, thereby compressing a working fluid positioned within the bore;
a working fluid flow rate sensor positioned to detect a change in flow rate of the working fluid at a location upstream of the pressure vessel, and generate a signal in response to the detected change in working fluid flow rate; and
a controller communicatively coupled to the working fluid flow rate sensor and to the motor such that the controller varies a rotational speed of the motor in response to receiving the signal generated in response to the detected change.

15. The fluid pressurization system of claim 14 wherein the hydraulic fluid acts upon a surface of the piston with a first area, the plunger includes a surface that acts upon the working fluid, the surface of the plunger having a second area, and the first area is larger than then second area.

16. The fluid pressurization system of claim 15 wherein a ratio of the first area to the second area is within a range of greater than or equal to 10 to 1 and less than or equal to 40 to 1.

17. The fluid pressurization system of claim 14, further comprising:
a hydraulic fluid flow rate sensor positioned to detect a change in flow rate of the hydraulic fluid, and generate a signal in response to the detected change,
wherein the controller is communicatively coupled to the hydraulic fluid flow rate sensor such that the controller varies the rotational speed of the motor in response to receiving the signal generated by the hydraulic fluid flow rate sensor.

18. The fluid pressurization system of claim 17 wherein the portion of the interior cavity is a first portion, and the fluid pressurization system further comprises:
a second portion of the interior cavity,
wherein movement of the piston in a first direction within the interior cavity expels hydraulic fluid from the second portion.

19. The fluid pressurization system of claim 18, further comprising:
a switcher that transitions from a first configuration, in which the pump conveys the hydraulic fluid into the first portion of the interior cavity, to a second configuration, in which the pump conveys the hydraulic fluid into the second portion of the interior cavity,
wherein entry of the hydraulic fluid into the second portion of the interior cavity moves the piston in a second direction within the interior cavity that is opposite the first direction.

20. The fluid pressurization system of claim 19 wherein the hydraulic fluid flow rate sensor is positioned between the pump and the switcher.

21. The fluid pressurization system of claim 14 wherein the pump includes a swash plate oriented at an angle relative to an axis of rotation of an output shaft of the motor, the output shaft rotatable relative to the swash plate about the axis of rotation,
wherein the controller, in response to a change in the angle of the swash plate, varies the rotational speed of the motor.

22. The fluid pressurization system of claim 21, further comprising:
a swash plate sensor that detects a change in the angle of the swash plate, and that generates a signal in response to the detected change,
wherein the controller is communicatively coupled to the swash plate sensor such that the controller varies the rotational speed of the motor in response to receiving the signal generated by the swash plate sensor.

23. A fluid pressurization system comprising:
a hydraulic pressure chamber;
a piston positioned within an interior cavity of the hydraulic pressure chamber;
a motor with an output shaft that rotates about an axis of rotation;
a pump coupled to the motor such that rotation of the output shaft conveys a hydraulic fluid into a portion of the interior cavity of the pressure chamber, the pump including a swash plate oriented at an angle relative to the axis of rotation of the output shaft of the motor, wherein entry of the hydraulic fluid into the portion of the interior cavity moves the piston within the interior cavity;
a controller communicatively coupled to the motor such that the controller varies a rotational speed of the motor in response to receiving a signal generated in response to a detected change in the angle of the swash plate.

24. The fluid pressurization system of claim 23, further comprising:
a swash plate sensor that detects the change in the angle of the swash plate, and that generates the signal in response to the detected change,
wherein the controller is communicatively coupled to the swash plate sensor such that the controller varies the rotational speed of the motor in response to receiving the signal generated by the swash plate sensor.

25. The fluid pressurization system of claim 23, further comprising:
a hydraulic fluid flow rate sensor positioned to detect a change in flow rate of the hydraulic fluid, and generate a signal in response to the detected change,
wherein the controller is communicatively coupled to the hydraulic fluid flow rate sensor such that the controller varies the rotational speed of the motor in response to receiving the signal generated by the hydraulic fluid flow rate sensor.

26. The fluid pressurization system of claim 23 wherein the portion of the interior cavity is a first portion, and the fluid pressurization system further comprises:
a second portion of the interior cavity,
wherein movement of the piston in a first direction within the interior cavity expels hydraulic fluid from the second portion.

27. The fluid pressurization system of claim 26, further comprising:
a switcher that transitions from a first configuration, in which the pump conveys the hydraulic fluid into the first portion of the interior cavity, to a second configuration, in which the pump conveys the hydraulic fluid into the second portion of the interior cavity,
wherein entry of the hydraulic fluid into the second portion of the interior cavity moves the piston in a second direction within the interior cavity that is opposite the first direction.

28. The fluid pressurization system of claim 27 wherein the hydraulic fluid flow rate sensor is positioned between the pump and the switcher.

29. The fluid pressurization system of claim 23, further comprising:
a working fluid pressure vessel positioned relative to the hydraulic pressure chamber such that at least a portion of a plunger carried by the piston is positioned within a bore of the working fluid pressure vessel,
wherein movement of the piston within the interior cavity moves the plunger within the bore, thereby compressing a working fluid positioned within the bore.

30. The fluid pressurization system of claim 29, further comprising:
a working fluid flow rate sensor positioned to detect a change in flow rate of the working fluid at a location upstream of the working fluid pressure vessel, and generate a signal in response to the detected change in working fluid flow rate.

31. The fluid pressurization system of claim 30 wherein the controller is communicatively coupled to the working fluid flow rate sensor such that the controller varies the rotational speed of the motor in response to receiving the signal generated by the working fluid flow rate sensor.

32. The fluid pressurization system of claim 29 wherein the hydraulic fluid acts upon a surface of the piston with a first area, the plunger includes a surface that acts upon the working fluid, the surface of the plunger having a second area, and the first area is larger than then second area.

33. The fluid pressurization system of claim 32 wherein a ratio of the first area to the second area is within a range of greater than or equal to 10 to 1 and less than or equal to 40 to 1.

34. A method of operation of a fluid pressurization system, the method comprising:
operating a motor such that an output shaft rotates at a first rotational speed about an axis of rotation;
conveying hydraulic fluid to a portion of an interior cavity of a hydraulic pressure chamber via a pump coupled to the motor such that rotation of the output shaft drives the pump, wherein the pump includes a swash plate oriented at an angle relative to the axis of rotation of the output shaft of the motor;
moving a piston positioned within the interior cavity of the hydraulic pressure chamber via entry of the hydraulic fluid into the portion of the interior cavity;
pressurizing working fluid within a bore of a working fluid pressure vessel, wherein the working fluid is pressurized via movement of a plunger carried by the piston such that movement of the piston within the interior cavity results in movement of the plunger within the bore;
generating a signal in response to a change in:
a flow rate of the hydraulic fluid;
a flow rate of the working fluid at a location upstream of the working fluid pressure vessel;
the angle of the swash plate relative to the output shaft; or
any combination thereof; and
changing an operating speed of the motor such that the output shaft rotates at a second rotational speed that is different than the first rotational speed.

35. The method of claim 34, further comprising:
measuring the flow rate of the hydraulic fluid with a hydraulic fluid flow rate sensor that generates the signal in response to a change in the flow rate of the hydraulic fluid.

36. The method of claim 35, wherein the change in the flow rate of the hydraulic fluid includes a decrease in the flow rate of the hydraulic fluid, and the second rotation speed is less than the first rotational speed.

37. The method of claim 35, wherein the change in the flow rate of the hydraulic fluid includes an increase in the flow rate of the hydraulic fluid, and the second rotation speed is greater than the first rotational speed.

38. The method of claim 34, further comprising:
measuring the flow rate of the working fluid at the location with a working fluid flow rate sensor that generates the signal in response to a change in the flow rate of the working fluid.

39. The method of claim 38, wherein the change in the flow rate of the working fluid includes a decrease in the flow rate of the working fluid, and the second rotation speed is less than the first rotational speed.

40. The method of claim 38, wherein the change in the flow rate of the working fluid includes an increase in the flow rate of the working fluid, and the second rotation speed is greater than the first rotational speed.

41. The method of claim 34, further comprising:
measuring the angle of the swash plate with a swash plate sensor that generates the signal in response to a change in the angle of the swash plate.

42. The method of claim 41, wherein the change in the angle of the swash plate includes a decrease in the angle, and the second rotation speed is greater than the first rotational speed.

43. The method of claim 41, wherein the change in the angle of the swash plate includes an increase in the angle, and the second rotation speed is less than the first rotational speed.

44. The method of claim 34 wherein generating the signal in response to the change occurs at an end of a power stroke of the piston positioned within the interior cavity of the hydraulic pressure chamber, during which the piston reverses its direction of movement.
